(19) United States
(12) Patent Application Publication
(10) Pub. No.: US 2023/0009550 A1
(43) Pub. Date: Jan. 12, 2023

(54) WATER FAUCET AND POOL ASSEMBLY WITH WATER FAUCET

(71) Applicant: ZHE DAI, ANQING (CN)

(72) Inventor: ZHE DAI, ANQING (CN)

(21) Appl. No.: 17/372,805

(22) Filed: Jul. 12, 2021

(51) Int. Cl. E03C 1/04; E04H 4/00

(52) U.S. Cl. CPC E03C 1/0403; E04H 4/0018

(57) ABSTRACT

A water faucet includes a first pipe, a housing and a first sealing ring. The first pipe includes a first sidewall, a second sidewall, a third sidewall and a first sliding portion. The first pipe includes a first accommodate space and an inlet. The housing includes a top wall, a second pipe and a second sliding portion corresponding to the first sliding portion. The second pipe includes a fourth sidewall connected with the top wall to form a second accommodate space and an outlet. When the first sliding portion slides to a first position, the first sealing ring is located between the fourth and the second sidewall to prevent water flowing between the first pipe and the housing. When the first sliding portion slides to a second position, water from the inlet can flow to the outlet via the first accommodate space, the though hole and the second accommodate space.

### FIELD OF THE INVENTION

The present invention relates generally to water faucets, and more particularly to a water faucet and a pool assembly with the water faucet.

### BACKGROUND OF THE INVENTION

As we all know, in our daily life, pool assemblies, such as portable and folding swimming pools for pets or children, have been increasing in popularity. However, it may be difficult to pump water into the existing pool assemblies, so a water faucet which is easy to pump water into a pool and a pool assembly with the water faucet are needed.

### SUMMARY OF THE INVENTION

In order to overcome the disadvantage of the existing pool assemblies, the present invention provides a water faucet and a pool assembly with the water faucet.

The present invention provides a water faucet including: a first pipe extending from a first direction, the first pipe including a first sidewall, a second sidewall, a third sidewall, a first connection wall, a second connection wall and at least one first sliding portion, the first sidewall, the second sidewall and the third sidewall arranged in the first direction, the first connection wall connected between the first sidewall and the second sidewall, the second connection wall connected between the second sidewall and the third sidewall, the first sliding portion disposed on the third sidewall, the first pipe having a first accommodate space and an inlet adjacent to the first sidewall and communicating with the first accommodate space; a housing extending from the first direction and partly located in the first accommodate space, the housing including a top wall, a second pipe and at least one second sliding portion, the second pipe including a fourth sidewall connected with the top wall to form a second accommodate space and an outlet far away from the top wall, the at least one second sliding portion disposed on the fourth sidewall and connected with the at least one first sliding portion with in a sliding mode, at least one through hole located at the fourth sidewall and communicating with the second accommodate space; a first sealing ring disposed around the fourth sidewall or disposed in an inner surface of the second sidewall; when the at least one first sliding portion slides to a first position along the at least one second sliding portion, the first sealing ring is located between the fourth sidewall and the second sidewall to prevent water flowing between the first pipe and the housing; and when the at least one first sliding portion slides to a second position from the first position along the at least one second sliding portion, the fourth sidewall slides away from the second wall, water from the inlet is able to flow to the outlet via the first accommodate space, the at least one though hole and the second accommodate space.

Further, the fourth sidewall includes a first portion, a second portion and a third portion, the first portion, the second portion and the third portion arranged in the first direction, the first portion is connected between the top wall and the second portion, the first sealing ring is disposed around the first portion, the at least one through hole is disposed on the second portion, the third portion contacts with an inner surface of the third sidewall, and an end of the third portion far away from the second portion protrudes from the third sidewall.

Further, an inner surface of the third portion includes internal thread configured to connect with external thread of other pipe.

Further, the water faucet further includes a second sealing ring disposed between the third portion and an inner surface of the third sidewall.

Further, the first portion includes a first groove accommodating the first sealing ring, and the third portion includes a second groove accommodating the second sealing ring.

Further, the third portion includes at least one mounting hole, the at least one second sliding portion includes at least one sliding chute, the at least one sliding portion passes though the at least one mounting hole and is mounted in the at least one mounting hole, an end of the at least one sliding portion is inserted into the at least one sliding chute so as to slide along the at least one sliding chute, and at least one though hole includes two though holes facing with each other.

Further, the at least one first sliding portion includes two first sliding portions facing with each other, the at least one sliding chute includes two sliding chutes disposed at two opposite sides of outer surface of the third portion, the at least one mounting hole includes two mounting holes facing with each other, each first sliding portion is mounted in a corresponding mounting hole and is inserted into a corresponding sliding chute.

Further, the sliding chute extends along a second direction different from the first direction, and when the first sliding portion slides along the sliding chute, the first pipe rotates about the housing.

Further, when the at least one first sliding portion slides to a first position along the at least one second sliding portion, the first connection wall contacts with the top wall.

Further, the second sidewall includes a main portion and an extending portion, the main portion is connected between the first connection wall and the second connection wall, the extending portion is connected with a joint between the main portion and the second connection wall and extends along the first direction.

The present invention also provides a pool assembly including: a pool including a water accommodate space and a water inlet communicating with the water accommodate space; a water faucet installed at the water inlet, including a first pipe, a housing and a first sealing ring, the first pipe extending from a first direction, the first pipe including a first sidewall, a second sidewall, a third sidewall, a first connection wall, a second connection wall and at least one first sliding portion, the first sidewall, the second sidewall and the third sidewall arranged in the first direction, the first connection wall connected between the first sidewall and the second sidewall, the second connection wall connected between the second sidewall and the third sidewall, the first sliding portion disposed on the third sidewall, the first pipe having a first accommodate space and an inlet adjacent to the first sidewall and communicating with the first accommodate space, the housing extending from the first direction and partly located in the first accommodate space, the housing including a top wall, a second pipe and at least one second sliding portion, the second pipe including a fourth sidewall connected with the top wall to form a second accommodate space and an outlet far away from the top wall, the at least one second sliding portion disposed on the fourth sidewall and connected with the at least one first sliding portion with in a sliding mode, at least one through hole located at the fourth sidewall and communicating with the second accommodate space, the first sealing ring disposed around the fourth sidewall or disposed in an inner surface of the second sidewall; when the at least one first sliding portion slides to a first position along the at least one second sliding portion, the first sealing ring is located between the fourth sidewall and the second sidewall to prevent water flowing between the first pipe and the housing; and when the at least one first sliding portion slides to a second position from the first position along the at least one second sliding portion, the fourth sidewall slides away from the second wall, water from the inlet is able to flow to the water inlet via the first accommodate space, the at least one though hole, the second accommodate space and the outlet.

Further, the fourth sidewall includes a first portion, a second portion and a third portion, the first portion, the second portion and the third portion arranged in the first direction, the first portion is connected between the top wall and the second portion, the first sealing ring is disposed around the first portion, the at least one through hole is disposed on the second portion, the third portion contacts with an inner surface of the third sidewall, and an end of the third portion far away from the second portion protrudes from the third sidewall.

Further, an inner surface of the third portion includes internal thread configured to connect with external thread of other pipe.

Further, the water faucet further includes a second sealing ring disposed between the third portion and an inner surface of the third sidewall.

Further, the first portion includes a first groove accommodating the first sealing ring, and the third portion includes a second groove accommodating the second sealing ring.

Further, the third portion includes at least one mounting hole, the at least one second sliding portion includes at least one sliding chute, the at least one sliding portion passes though the at least one mounting hole and is mounted in the at least one mounting hole, an end of the at least one sliding portion is inserted into the at least one sliding chute so as to slide along the at least one sliding chute, and at least one though hole includes two though holes facing with each other.

Further, the at least one first sliding portion includes two first sliding portions facing with each other, the at least one sliding chute includes two sliding chutes disposed at two opposite sides of outer surface of the third portion, the at least one mounting hole includes two mounting holes facing with each other, each first sliding portion is mounted in a corresponding mounting hole and is inserted into a corresponding sliding chute.

Further, the sliding chute extends along a second direction different from the first direction, and when the first sliding portion slides along the sliding chute, the first pipe rotates about the housing.

Further, when the at least one first sliding portion slides to a first position along the at least one second sliding portion, the first connection wall contacts with the top wall.

Further, the second sidewall includes a main portion and an extending portion, the main portion is connected between the first connection wall and the second connection wall, the extending portion is connected with a joint between the main portion and the second connection wall and extends along the first direction.

It can be understood, the water faucet is easy to use and provide water into the pool, the user experience of the water faucet and the pool assembly can be improved.

### BRIEF DESCRIPTIONS OF THE DRAWINGS

For the purpose of a clearer description of the embodiments in this application or technical solutions in prior art, below is a brief introduction of the attached drawings needed to be used in the description of the embodiments or prior art. Apparently, the attached drawings in the following description are only some embodiments indicated in the present application. For ordinary skill in the art, they may obtain other drawings according to these attached drawings without any innovative laboring.

The present disclosure will be further described with reference to the attached drawings and the embodiments hereunder:

FIG. 1 is a schematic diagram of a water faucet according to one embodiment of the present invention;

FIG. 2 is another schematic diagram of the water faucet of FIG. 1;

FIG. 3 is an explosive view of the water faucet of FIG. 1;

FIG. 4 is another explosive view of the water faucet of FIG. 1;

FIG. 5 is a cross-section view of the water faucet of FIG. 1 when the water faucet is turned on;

FIG. 6 is a cross-section view of the water faucet of FIG. 1 when the water faucet is turned off;

FIG. 7 is a schematic diagram of a pool assembly with the water faucet of FIG. 1 according to one embodiment of the present invention; and

FIG. 8 is an enlarge view of the pool assembly of FIG. 7.

### DETAILED DESCRIPTION OF THE ILLUSTRATED EMBODIMENTS

In order to provide a clear understanding of the objects, features, and advantages of the embodiments, the following are detailed and complete descriptions to the technological solutions adopted in the embodiments. Obviously, the descriptions are part of the whole embodiments. The other embodiments which are not processed creatively by technicians of ordinary skills in the field are under the protection of this disclosure. The same is given with reference to the drawings and specific embodiments. It should be noted that non-conflicting embodiments in the disclosure and the features in the embodiments may be combined with each other without conflict.

In the following description, numerous specific details are set forth in order to provide a full understanding of the disclosure. The disclosure may be practiced otherwise than as described herein. The following specific embodiments are not to limit the scope of the disclosure.

Unless defined otherwise, all technical and scientific terms herein have the same meaning as used in the field of the art as generally understood. The terms used in the disclosure are to describe particular embodiments and are not intended to limit the disclosure.

The disclosure, referencing the accompanying drawings, is illustrated by way of examples and not by way of limitation. It should be noted that references to “an” or “one” embodiment in this disclosure are not necessarily to the same embodiment, and such references mean “at least one.”

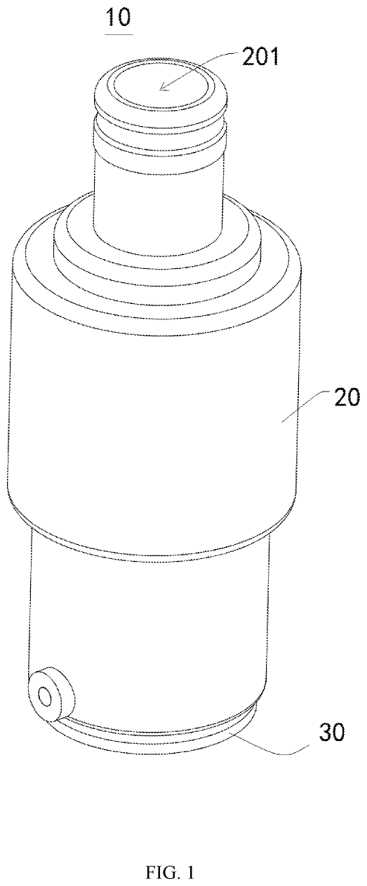

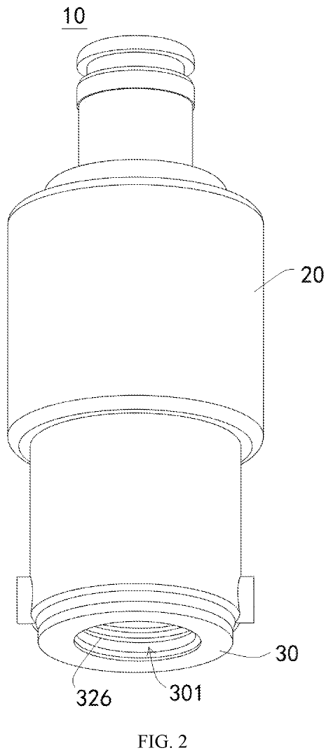

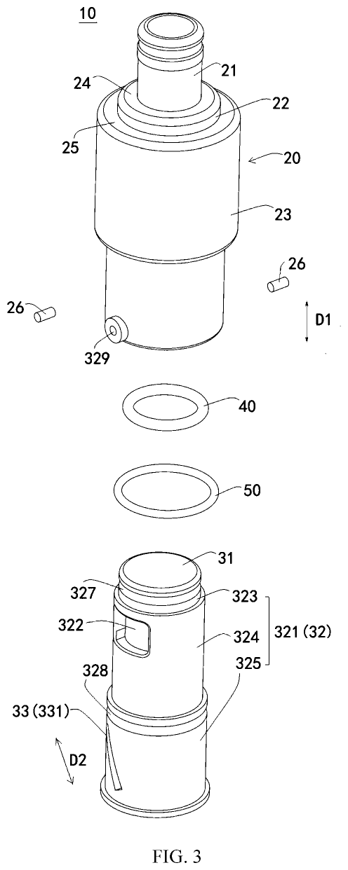

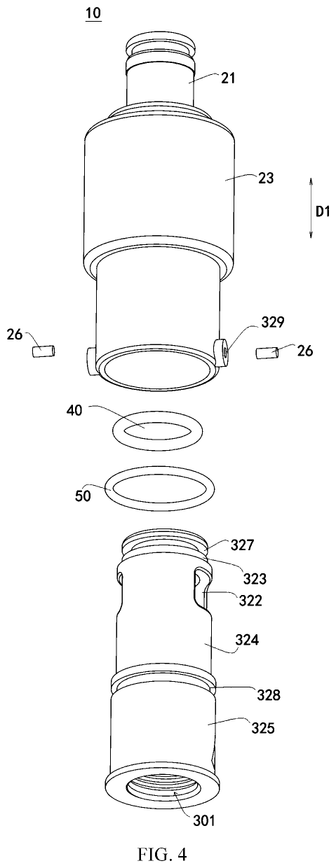

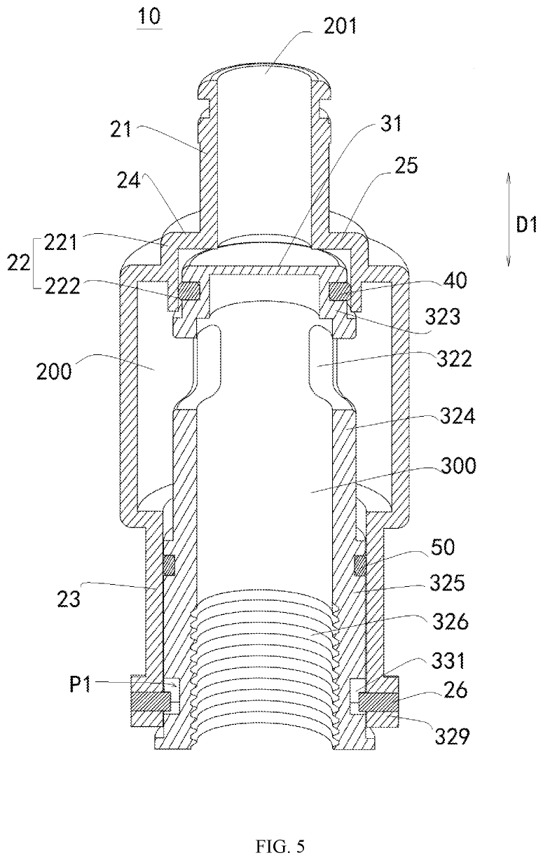

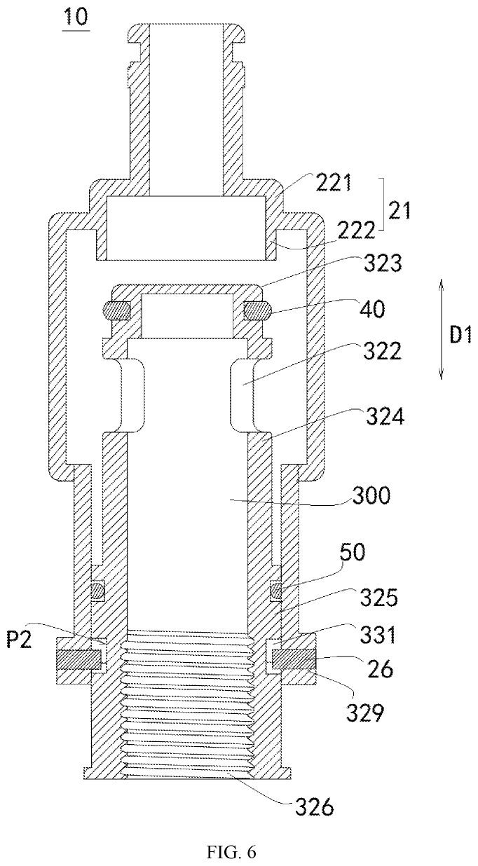

Referring to FIGS. 1-6, a water faucet 10 includes a first pipe 20, a housing 30, a first sealing ring 40 and a second sealing ring 50. The first pipe 20 extends from a first direction D1. The first pipe 20 includes a first sidewall 21, a second sidewall 22, a third sidewall 23, a first connection wall 24, a second connection wall 25 and at least one first sliding portion 26. The first sidewall 21, the second sidewall 22 and the third sidewall 23 are arranged in the first direction D1. The first connection wall 24 is connected between the first sidewall 21 and the second sidewall 22. The second connection wall 25 is connected between the second sidewall 22 and the third sidewall 23. The first sliding portion is disposed on the third sidewall 23. The first pipe 20 has a first accommodate space 200 and an inlet 201 adjacent to the first sidewall 21 and communicating with the first accommodate space 200. The inlet 201 is configured to connect other pipe to receive water.

The housing 30 extends from the first direction D1 and partly is located in the first accommodate space 200. The housing 30 includes a top wall 31, a second pipe 32 and at least one second sliding portion 33. The second pipe 32 includes a fourth sidewall 321 connected with the top wall 31 to form a second accommodate space 300 and an outlet 301 far away from the top wall 31. The at least one second sliding portion 33 is disposed on the fourth sidewall 321 and is connected with the at least one first sliding portion 26 with in a sliding mode. At least one through hole 322 is located at the fourth sidewall 321 and communicating with the second accommodate space 300. The outlet 301 is configured to connect with other pipe, pool assembly or other container and provide water to other pipe, the pool assembly or other container.

In the embodiment, the first sealing ring 40 is disposed around the fourth sidewall 321. In other embodiment, the first sealing ring 40 can be disposed in an inner surface of the second sidewall 22. It can be understood, the first sealing ring 40 can be made of rubber.

When the at least one first sliding portion 26 slides to a first position P1 along the at least one second sliding portion 33, the water faucet 10 is turned off, the first sealing ring 40 is located between the fourth sidewall 321 and the second sidewall 22 to prevent water flowing between the first pipe 20 and the housing 30. When the at least one first sliding portion 26 slides to a second position P2 from the first position along the at least one second sliding portion 33, the water faucet 10 is turned on, the fourth sidewall 321 slides away from the second wall 22, water from the inlet 201 is able to flow to the outlet 301 via the first accommodate space 200, the at least one though hole 322 and the second accommodate space 300. The second position P2 is far away from the top wall 31, and the first position P1 is located between the second position P2 and the top wall 31. In addition, when the at least one first sliding portion 26 slides to a first position P1 along the at least one second sliding portion 33, the first connection wall 24 contacts with the top wall 31. The second sidewall 22 includes a main portion 221 and an extending portion 222, the main portion 221 is connected between the first connection wall 24 and the second connection wall 25, the extending portion 222 is connected with a joint between the main portion 221 and the second connection wall 25 and extends along the first direction D1.

The fourth sidewall 321 includes a first portion 323, a second portion 324 and a third portion 325. The first portion 323, the second portion 324 and the third portion 325 are arranged in the first direction D1 and connected in series. The first portion 323 is connected between the top wall 31 and the second portion 324. The first sealing ring 40 is disposed around the first portion 323. The at least one through hole 322 is disposed on the second portion 324. The third portion 325 contacts with an inner surface of the third sidewall 23, and an end of the third portion 325 far away from the second portion 324 protrudes from the third sidewall 23. An inner surface of the third portion 325 includes internal thread 326 configured to connect with external thread of other pipe, the pool assembly or other container. The second sealing ring 50 is disposed between the third portion 325 and the inner surface of the third sidewall 23.

Further, the first portion 323 can includes a first groove 327 accommodating the first sealing ring 40, such that the first sealing ring 40 can be limited in the first groove 327 and avoid moving. The third portion 325 includes a second groove 328 accommodating the second sealing ring 50, such that the second sealing ring 50 can be limited in the second groove 328 so as to avoid moving.

The third portion 325 includes at least one mounting hole 329. The at least one second sliding portion 33 includes at least one sliding chute 331. The at least one sliding portion 26 passes though the at least one mounting hole 329 and is mounted in the at least one mounting hole 329, an end of the at least one sliding portion 26 is inserted into the at least one sliding chute 331 so as to slide along the at least one sliding chute 331. The at least one though hole 322 includes two though holes 322 facing with each other.

The at least one first sliding portion 26 includes two first sliding portions 26 facing with each other. The at least one sliding chute 331 includes two sliding chutes 331 disposed at two opposite sides of outer surface of the third portion 325. The at least one mounting hole 329 includes two mounting holes 329 facing with each other. Each first sliding portion 26 is mounted in a corresponding mounting hole 329 and is inserted into a corresponding sliding chute 331 so as to slide in the corresponding sliding chute 331.

The sliding chute 331 extends along a second direction D2 different from the first direction D1, and when the first sliding portion 26 slides along the sliding chute 331, the first pipe 20 rotates about the housing 30 and also has a displacement in the first direction D1 according to the housing 30.

When the water faucet 10 is used, the inlet 201 can be connected with an water providing device (such as other pipe or other water faucet), and the outlet 301 can be connected with an water receiving device (such as a pool for pets or children). The user can rotate the first pipe 20 about the housing 30, such that the first sliding portion 26 slides to the first position P1 along the second sliding portion 33, the first sealing ring 40 is located between the fourth sidewall 321 and the second sidewall 22 to prevent water flowing between the first pipe 20 and the housing 30. Furthermore, the user can rotate the first pipe 20 about the housing 30, such that the first sliding portion 26 slides to the second position P2 from the first position along the at least one second sliding portion 33, the fourth sidewall 321 slides away from the second wall 22, water from the inlet 201 is able to flow to the outlet 301 via the first accommodate space 200, the at least one though hole 322 and the second accommodate space 300.

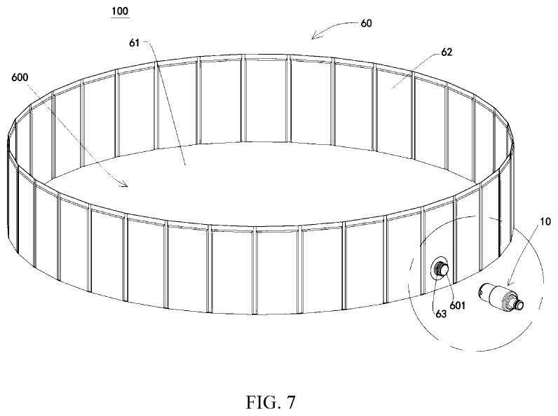

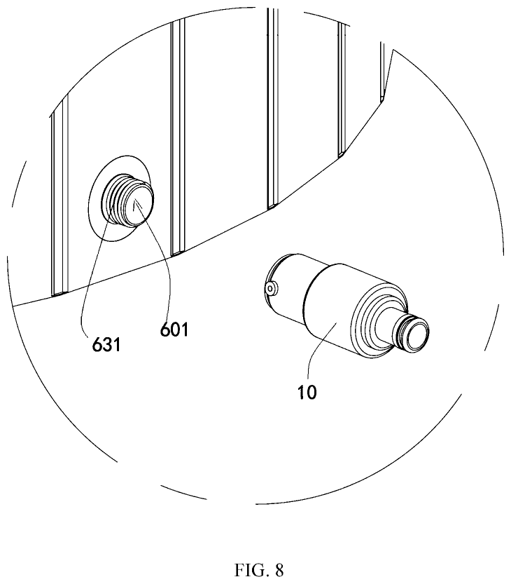

Referring to FIG. 7 and FIG. 8, the invention also provides a pool assembly 100 for pets or children. The pool assembly 100 includes a pool 60 and the water faucet 10. The pool 60 includes a water accommodate space 600 and a water inlet 601 communicating with the water accommodate space 600. The water faucet 10 is installed at the water inlet 601.

The pool 60 includes a bottom plate 61, a side plate 62, and a third pipe 63. The side plate 62 is connected with the bottom plate 61 to form the water accommodate space 600. The third pipe 63 is installed at the side plate 62 and has the water inlet 601 communicating with the water accommodate space 600. An outer surface of the third pipe 63 can includes external thread 631, and the external thread 631 is configured to connect with the internal thread 326 of the water faucet 10 so as to install the water faucet 10 on the pool 60.

It can be understood, the water faucet 10 is easy to use and provide water into the pool, the user experience of the water faucet 10 and the pool assembly 100 can be improved.

Finally, it should be noted that above embodiments are merely used for illustrating the technical solutions of the invention, rather than limiting the invention; though the invention is illustrated in detail with reference to the aforementioned embodiments, it should be understood by those of ordinary skill in the art that modifications may still be made on the technical solutions disclosed in the aforementioned respective embodiments, or equivalent substitutions may be made to a part of technical features thereof; and these modifications or substitutions do not make the essence of the corresponding technical solutions depart from the spirit and scope of the technical solutions of the respective embodiments of the disclosure.

What is claimed is and desired to be protected by Letters Patent is:

1. A water faucet, comprising:
a first pipe extending from a first direction, the first pipe comprising a first sidewall, a second sidewall, a third sidewall, a first connection wall, a second connection wall and at least one first sliding portion, the first sidewall, the second sidewall and the third sidewall arranged in the first direction, the first connection wall connected between the first sidewall and the second sidewall, the second connection wall connected between the second sidewall and the third sidewall, the first sliding portion disposed on the third sidewall, the first pipe having a first accommodate space and an inlet adjacent to the first sidewall and communicating with the first accommodate space;
a housing extending from the first direction and partly located in the first accommodate space, the housing comprising a top wall, a second pipe and at least one second sliding portion, the second pipe comprising a fourth sidewall connected with the top wall to form a second accommodate space and an outlet far away from the top wall, the at least one second sliding portion disposed on the fourth sidewall and connected with the at least one first sliding portion with in a sliding mode, at least one through hole located at the fourth sidewall and communicating with the second accommodate space;
a first sealing ring disposed around the fourth sidewall or disposed in an inner surface of the second sidewall;
wherein when the at least one first sliding portion slides to a first position along the at least one second sliding portion, the first sealing ring is located between the fourth sidewall and the second sidewall to prevent water flowing between the first pipe and the housing; when the at least one first sliding portion slides to a second position from the first position along the at least one second sliding portion, the fourth sidewall slides away from the second wall, water from the inlet is able to flow to the outlet via the first accommodate space, the at least one though hole and the second accommodate space.

2. The water faucet of claim 1, wherein the fourth sidewall comprises a first portion, a second portion and a third portion, the first portion, the second portion and the third portion arranged in the first direction, the first portion is connected between the top wall and the second portion, the first sealing ring is disposed around the first portion, the at least one through hole is disposed on the second portion, the third portion contacts with an inner surface of the third sidewall, and an end of the third portion far away from the second portion protrudes from the third sidewall.

3. The water faucet of claim 2, wherein an inner surface of the third portion comprises internal thread configured to connect with external thread of other pipe.

4. The water faucet of claim 2, wherein the water faucet further comprises a second sealing ring disposed between the third portion and an inner surface of the third sidewall.

5. The water faucet of claim 4, wherein the first portion comprises a first groove accommodating the first sealing ring, and the third portion comprises a second groove accommodating the second sealing ring.

6. The water faucet of claim 2, wherein the third portion comprises at least one mounting hole, the at least one second sliding portion comprises at least one sliding chute, the at least one sliding portion passes though the at least one mounting hole and is mounted in the at least one mounting hole, an end of the at least one sliding portion is inserted into the at least one sliding chute so as to slide along the at least one sliding chute, and at least one though hole comprises two though holes facing with each other.

7. The water faucet of claim 6, wherein the at least one first sliding portion comprises two first sliding portions facing with each other, the at least one sliding chute comprises two sliding chutes disposed at two opposite sides of outer surface of the third portion, the at least one mounting hole comprises two mounting holes facing with each other, each first sliding portion is mounted in a corresponding mounting hole and is inserted into a corresponding sliding chute.

8. The water faucet of claim 6, wherein the sliding chute extends along a second direction different from the first direction, and when the first sliding portion slides along the sliding chute, the first pipe rotates about the housing.

9. The water faucet of claim 1, wherein when the at least one first sliding portion slides to a first position along the at least one second sliding portion, the first connection wall contacts with the top wall.

10. The water faucet of claim 1, wherein the second sidewall comprises a main portion and an extending portion, the main portion is connected between the first connection wall and the second connection wall, the extending portion is connected with a joint between the main portion and the second connection wall and extends along the first direction.

11. A pool assembly, comprising:
a pool comprising a water accommodate space and a water inlet communicating with the water accommodate space;
a water faucet installed at the water inlet, comprising a first pipe, a housing and a first sealing ring;
the first pipe extending from a first direction, the first pipe comprising a first sidewall, a second sidewall, a third sidewall, a first connection wall, a second connection wall and at least one first sliding portion, the first sidewall, the second sidewall and the third sidewall arranged in the first direction, the first connection wall connected between the first sidewall and the second sidewall, the second connection wall connected between the second sidewall and the third sidewall, the first sliding portion disposed on the third sidewall, the first pipe having a first accommodate space and an inlet adjacent to the first sidewall and communicating with the first accommodate space;
the housing extending from the first direction and partly located in the first accommodate space, the housing comprising a top wall, a second pipe and at least one second sliding portion, the second pipe comprising a fourth sidewall connected with the top wall to form a second accommodate space and an outlet far away from the top wall, the at least one second sliding portion disposed on the fourth sidewall and connected with the at least one first sliding portion with in a sliding mode, at least one through hole located at the fourth sidewall and communicating with the second accommodate space; and
the first sealing ring disposed around the fourth sidewall or disposed in an inner surface of the second sidewall;
wherein when the at least one first sliding portion slides to a first position along the at least one second sliding portion, the first sealing ring is located between the fourth sidewall and the second sidewall to prevent water flowing between the first pipe and the housing; when the at least one first sliding portion slides to a second position from the first position along the at least one second sliding portion, the fourth sidewall slides away from the second wall, water from the inlet is able to flow to the water inlet via the first accommodate space, the at least one though hole, the second accommodate space and the outlet.

12. The pool assembly of claim 11, wherein the fourth sidewall comprises a first portion, a second portion and a third portion, the first portion, the second portion and the third portion arranged in the first direction, the first portion is connected between the top wall and the second portion, the first sealing ring is disposed around the first portion, the at least one through hole is disposed on the second portion, the third portion contacts with an inner surface of the third sidewall, and an end of the third portion far away from the second portion protrudes from the third sidewall.

13. The pool assembly of claim 12, wherein an inner surface of the third portion comprises internal thread, the pool comprises a bottom plate, a side plate, and a third pipe, the side plate is connected with the bottom plate to form the water accommodate space, the third pipe is installed at the side plate and has the water inlet communicating with the water accommodate space, an outer surface of the third pipe includes external thread, and the external thread is configured to connected with the internal thread of the water faucet so as to install the water faucet on the pool.

14. The pool assembly of claim 12, wherein the water faucet further comprises a second sealing ring disposed between the third portion and an inner surface of the third sidewall.

15. The pool assembly of claim 14, wherein the first portion comprises a first groove accommodating the first sealing ring, and the third portion comprises a second groove accommodating the second sealing ring.

16. The pool assembly of claim 12, wherein the third portion comprises at least one mounting hole, the at least one second sliding portion comprises at least one sliding chute, the at least one sliding portion passes though the at least one mounting hole and is mounted in the at least one mounting hole, an end of the at least one sliding portion is inserted into the at least one sliding chute so as to slide along the at least one sliding chute, and at least one though hole comprises two though holes facing with each other.

17. The pool assembly of claim 16, wherein the at least one first sliding portion comprises two first sliding portions facing with each other, the at least one sliding chute comprises two sliding chutes disposed at two opposite sides of outer surface of the third portion, the at least one mounting hole comprises two mounting holes facing with each other, each first sliding portion is mounted in a corresponding mounting hole and is inserted into a corresponding sliding chute.

18. The pool assembly of claim 16, wherein the sliding chute extends along a second direction different from the first direction, and when the first sliding portion slides along the sliding chute, the first pipe rotates about the housing.

19. The pool assembly of claim 11, wherein when the at least one first sliding portion slides to a first position along the at least one second sliding portion, the first connection wall contacts with the top wall.

20. The pool assembly of claim 11, wherein the second sidewall comprises a main portion and an extending portion, the main portion is connected between the first connection wall and the second connection wall, the extending portion is connected with a joint between the main portion and the second connection wall and extends along the first direction.
